(19) United States
(12) Patent Application Publication
(10) Pub. No.: US 2007/0008952 A1
(43) Pub. Date: Jan. 11, 2007

(54) Internet telephone network system

(75) Inventor: Yean Ching Miao, Banchiau City (TW)

Correspondence Address: BIRCH STEWART KOLASCH & BIRCH, PO BOX 747, FALLS CHURCH, VA, 22040-0747, US

(73) Assignee: VODTEL COMMUNICATIONS INC.

(21) Appl. No.: 11/175,758

(22) Filed: Jul. 7, 2005

(51) Int. Cl. H04L 12/56; H04L 12/28; H04L 12/66

(52) U.S. Cl. 370/352; 370/408

(57) ABSTRACT

An Internet telephone network system is cooperated with a plurality of terminal devices, each of which has a local number and an IP address. The Internet telephone network system comprises at least two office-code serving units, and at least one area-code serving unit. In addition, the system may further comprise other server units such as at least two country-code server units and at least one international relay serving unit. Thus, the Internet telephone network system of the invention can establish the telephone network system without the conventional exchanges and allow the user to make a phone call by dialing the telephone number conforming to, for example, the E. 164 Standard of the ITU.

### BACKGROUND OF THE INVENTION

1. Field of Invention

The invention relates to a telephone network system and, in particular, to an internet telephone network system that can establish a connection through Internet.

2. Related Art

In the recently modern life, telephone network is one of the most convenient communication system. Besides, the telephone network has been developed for a long time and the users usually use the telephones (as a habit) to communicate with others, so that the telephone is still the first choice of most people to make a communication connection.

Regarding to the conventional telephone network system, the local telecommunication organization, such as the telephone local exchange office, must build physical telephone wires and telephone exchanges in advance, which construct the public switched telephone network (PSTN). As shown in FIG. 1, in this case, the user can dial a phone number with the terminal device 11 (telephone) to establish a connection with the other terminal device 12 through the complex operations of the PSTN 20, which include switch actions of a plurality of exchangers 21.

As mentioned above, the telephone number to be dialed is provided by the local telecommunication organization and is set under the rules (E.164 Standard) of International Telecommunication Union (ITU). Take a telephone number “0-2-8226-1234” as an example. “0” is a long-distance access code of Taiwan for representing the telephone number is a long-distance call. “2” is an area code (such as a Taipei county area code) of the telephone number. “8226” is an office code (such as a Jhonghe city office code) of the telephone number. “1234” is a local number for representing the location of the phone number. In this case, if the caller is of the same area code or the same office code, he/she dials only the office code and the local number such as “8226-1234” for establishing the connection with the PSTN. If the caller is of the same country code and different area code, he/she must dial the long-distance access code, the area code, office code, and the local number such as “0-2-8226-1234” for establishing the connection with the PSTN. If the caller is of different country code, he/she must dial the international access code, the country code, the area code, the office code, and the local number such as “011-886-2-8226-1234” for establishing the connection with the PSTN.

However, PSTN includes many physical exchangers, which are very expansive and have large dimensions. Thus, the telecommunication organization has to pay a lot of money for the exchangers and to spend the cost on transporting and accommodating them. For example, the building or storage room for accommodating the exchangers must be build in advance. In addition, the conventional exchanger has the maximum limitation for the available terminal devices. Accordingly, at the populous region or the place of large requirement of telephones, more exchangers are necessary. However, this region usually has higher rent cost or building cost, so the load of the telecommunication organization increases. Besides, the skilled person in the art has disclosed the technology, such as the VoIP technology, of using Internet to establish the connection. In this case, the exchangers of the conventional PSTN are still required. Otherwise, only the simple network servers are used to connect two terminal devices, and the function of the conventional exchanger can not be replaced. Thus, although the user can make a phone call by using the conventional dialing method, the previously mentioned problem of high cost is still not solved. Moreover, the present network server has the limitation on scale up and can not provide the telephone number conforming to the E. 164 Standard of the ITU. As a result, the user can not make a phone call by using the conventional dialing method such as dialing the conventional telephone number.

Therefore, it is an important subject of the invention to provide a telephone network system that does not need the conventional exchanges and can allow the user to make a phone call by using the conventional dialing method such as dialing the conventional telephone number (conforming to the E.164 Standard of the ITU).

### SUMMARY OF THE INVENTION

In view of the foregoing, the invention is to provide an Internet telephone network system that does not need the conventional exchanges and can allow the user to make a phone call by dialing the telephone number conforming to the E.164 Standard of the ITU.

To achieve the above, an Internet telephone network system includes at least two office-code serving units and at least one area-code serving unit. The Internet telephone network system is cooperated with a plurality of terminal devices, each of which has a local number and an IP address. Each office-code serving unit has an office code and a connection with at least one terminal device through Internet, and records the local numbers and IP addresses of the corresponding terminal devices. The area-code serving unit has an area code and a connection with at least one of the office-code serving units through Internet, and records the office code of the corresponding office-code serving unit. The local number(s), office code(s), and area code are set under the rules (E. 164 Standard) of International Telecommunication Union (ITU). Thus, when a first terminal device is going to make a connection with a second terminal device, the system receives a request from the first terminal device through Internet, and returns the IP address of the second terminal device to the first terminal device through Internet. The first terminal device then makes a connection with the second device via Internet according to the received IP address.

In another aspect of the invention, an Internet telephone network system includes at least two office-code serving units, at least two area-code serving units, at least two country-code serving units, and at least one international relay serving unit. The Internet telephone network system is cooperated with a plurality of terminal devices, each of which has a local number and an IP address. In the invention, each office-code serving unit has an office code and a connection with at least one of the terminal devices through Internet. The office-code serving units record the local numbers and the IP addresses of the corresponding terminal devices, respectively. Each area-code serving unit has an area code and a connection with at least one of the office-code serving units through Internet. The area-code serving units record the office codes of the corresponding office-code serving units, respectively. Each country-code serving unit has a country code and a connection with at least one of the area-code serving units through Internet. The country-code serving units record the area codes of the corresponding area-code serving units, respectively. The international relay serving unit has connections with the country-code serving units through Internet, and records the country codes of the country-code serving units. In the invention, the local numbers, the office codes, the area codes, and the country codes are set under the rules (E. 164 Standard) of International Telecommunication Union (ITU). When a first terminal device of the terminal devices is going to make a connection with a second terminal device of the terminal devices, the system receives a request from the first terminal device through Internet, and returns the IP address of the second terminal device to the first terminal device through Internet according to the request, and the first terminal device then makes a connection with the second terminal device via Internet according to the received IP address.

As mentioned above, the Internet telephone network system of the invention utilizes several serving units to establish the virtual exchange system. Therefore, the connections between the serving units are established through Internet, so that the request can be transmitted through Internet. The Internet telephone network system of the invention can thus establish the telephone network system without the conventional exchanges and allow the user to make a phone call by dialing the telephone number conforming to the E. 164 Standard of the ITU. As a result, the cost of the conventional exchangers and the accommodating place thereof can be saved, and the maximum limitation for the available terminal devices can be eliminated.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing the conventional telephone network system;

FIG. 2 is a schematic overall illustration of an Internet telephone network system according to a preferred embodiment of the invention;

FIG. 3 is a schematic illustration showing a part of the Internet telephone network system according to the preferred embodiment of the invention, wherein the dialed number has the same office code or area code as that of the caller;

FIG. 4 is a schematic illustration showing a part of the Internet telephone network system according to the preferred embodiment of the invention, wherein the dialed number has the same country code and different area code as that of the caller; and

FIG. 5 is a schematic illustration showing a part of the Internet telephone network system according to the preferred embodiment of the invention, wherein the dialed number has the different country code as that of the caller.

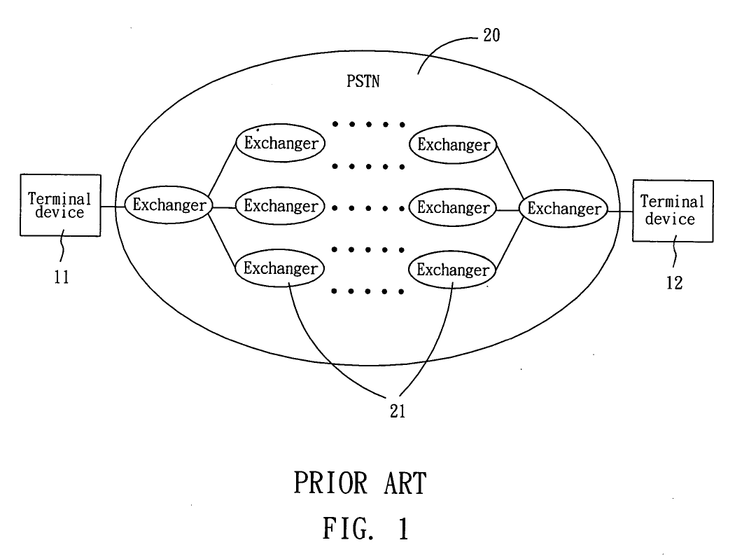

### DETAILED DESCRIPTION OF THE INVENTION

The present invention will be apparent from the following detailed description, which proceeds with reference to the accompanying drawings, wherein the same references relate to the same elements.

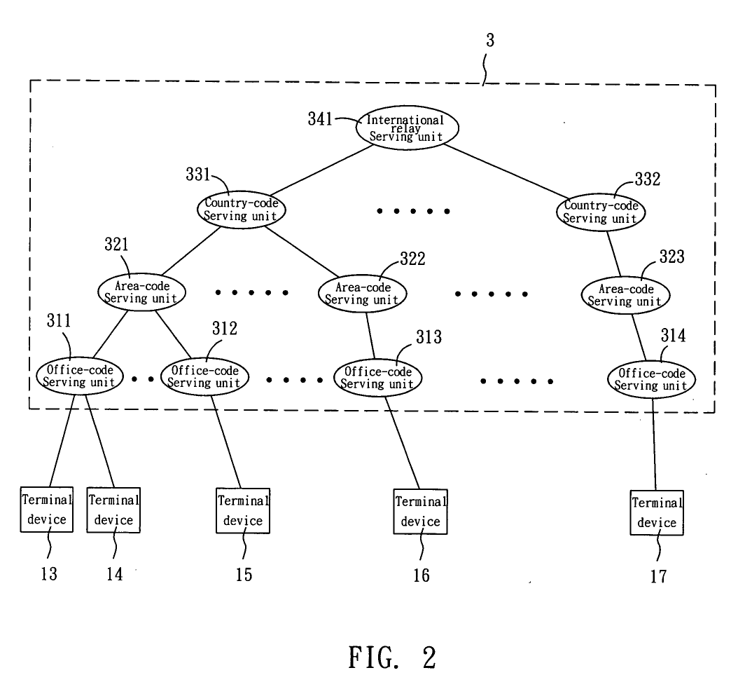

With reference to FIG. 2, an Internet telephone network system 3 according to a preferred embodiment of the invention is cooperated with a plurality of terminal devices 13 to 17. The terminal devices 13 to 17 respectively have a local number and an IP address.

In the invention, the Internet telephone network system includes at least two office-code serving units and at least one area-code serving unit. In this embodiment, the Internet telephone network system 3 includes several office-code serving units 311 to 314, several area-code serving units 321 to 323, several country-code serving units 331 to 332, and an international relay serving unit 341.

The office-code serving units 311 to 314 respectively have an office code and a connection with at least one of the terminal devices 13 to 17 through Internet. Each office-code serving unit 311, 312, 313 or 314 records the local number(s) and the IP address(es) of the corresponding terminal device(s). In the present embodiment, the office code of the office-code serving unit 311 is “8226”, and the local numbers of the terminal devices 13 and 14 connecting to the office-code serving unit 311 are “1234” and “0001” respectively. The office code of the office-code serving unit 312 is “2968”, and the local number of the terminal device 15 connecting to the office-code serving unit 312 is “4321”. The office code of the office-code serving unit 313 is “531”, and the local number of the terminal device 16 connecting to the office-code serving unit 313 is “1357”. The office code of the office-code serving unit 314 is “6261”, and the local number of the terminal device 17 connecting to the office-code serving unit 314 is “2468”. To be noted, the office-code serving units 311 to 314 and the terminal devices 13 to 17 are respectively connected to Internet, and the terminal devices 13 to 17 connect to the corresponding office-code serving units 311 to 314 so as to download different and/or default local numbers and IP addresses from the office-code serving units 311 to 314.

The area-code serving units 321 to 323 respectively have an area code and a connection with at least one of the office-code serving units 311 to 314 through Internet. Each area-code serving unit 321, 322 or 323 records the office code(s) of the corresponding office-code serving unit(s). In the present embodiment, the area code of the area-code serving unit 321 is “2”, and the area-code serving unit 321 is connected with the office-code serving units 311 and 312. The area code of the area-code serving unit 322 is “3”, and the area-code serving unit 322 is connected with the office-code serving unit 313. The area code of the area-code serving unit 323 is “408”, and the area-code serving unit 323 is connected with the office-code serving unit 314. To be noted, the area-code serving units 321 to 323 are respectively connected to Internet, and the office-code serving units 311 to 314 connect to the corresponding area-code serving units 321 to 323 so as to download different and/or default office codes from the area-code serving units 321 to 323.

The country-code serving units 331 to 332 respectively have a country code and a connection with at least one of the area-code serving units 321 to 323 through Internet. Each country-code serving unit 331 or 332 records the area code(s) of the corresponding area-code serving unit(s). In the present embodiment, the country code of the country-code serving unit 331 is “886”, and the country-code serving unit 331 is connected with the area-code serving unit 321 and 322. The country code of the country-code serving unit 332 is “1”, and the country-code serving unit 332 is connected with the area-code serving unit 323. To be noted, the country-code serving units 331 and 332 are respectively connected to Internet, and the area-code serving units 321 to 323 connect to the corresponding country-code serving units 331 and 332 so as to download different and/or default area codes from the country-code serving units 331 and 332.

The international relay serving unit 341 has connections with the country-code serving units 331 and 332 through Internet, and records the country codes of the country-code serving units 331 and 332. To be noted, the international relay serving units 341 is connected to Internet, and the country-code serving units 331 and 332 connect to the international relay serving unit 341 so as to download different and/or default country codes from the international relay serving unit 341.

When one terminal device (such as the terminal device 13) is going to make a connection with another terminal device (such as the terminal device 14, 15, 16 or 17), the Internet telephone network system 3 receives a request from the terminal device 13 through Internet, and returns the IP address of another terminal device 14, 15, 16 or 17 to the terminal device 13 through Internet according to the request. Then, the terminal device 13 makes a connection with another terminal device 14, 15, 16 or 17 via Internet according to the received IP address.

In the present embodiment, the previous-mentioned local numbers, office codes, area codes, and country codes are set under the rules (E. 164 Standard) of International Telecommunication Union (ITU). In other words, to make a call through the Internet telephone network system 3, the caller can dial the conventional telephone number with the terminal device 13 for establishing the communication connection with another terminal device 14, 15, 16 or 17 via Internet. Thus, the caller is unnecessary to memorize or use new number strings for other terminal devices.

To make the invention more comprehensive, several examples are described hereinafter for illustrating the virtual exchange system established by the Internet telephone network system 3.

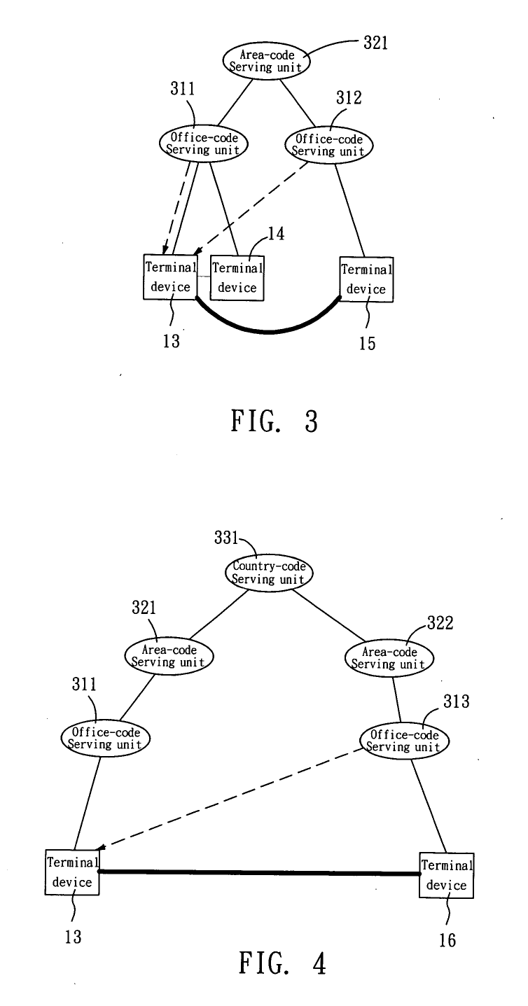

With reference to FIG. 3, when the terminal device 13 is going to make a connection with the terminal device 14, the caller dials a conventional telephone number “8226-0001” with the terminal device 13. The terminal device 13 then outputs a request to the office-code serving unit 311 through Internet according to the telephone number “8226-0001”. In this case, the office-code serving unit 311 records the local numbers and IP addresses of the terminal devices 13 and 14. Thus, when receiving the request from the terminal device 13 through Internet, the office-code serving unit 311 returns the IP address of the terminal device 14 to the terminal device 13 through Internet according to the request and the telephone number “8226-0001”. Finally, the terminal device 13 then makes the connection with the terminal device 14 via Internet according to the received IP address of the terminal device 14.

In addition, when the terminal device 13 is going to make a connection with the terminal device 15, the caller dials a conventional telephone number “29684321” with the terminal device 13. The terminal device 13 then outputs a request to the office-code serving unit 311 through Internet according to the telephone number “29684321”. The office-code serving unit 311 determines that the office code represented by the telephone number “2968-4321” is different from that of the office-code serving unit 311, and then transmits the request to the area-code serving unit 321 through Internet. In this case, the area-code serving unit 321 records the office code “2968” of the office-code serving unit 312. Thus, when receiving the request from the office-code serving unit 311 through Internet, the area-code serving unit 321 transmits the request to the office-code serving unit 312, which records the local number and IP address of the terminal device 15. When receiving the request from the area-code serving unit 321 through Internet, the office-code serving unit 312 returns the IP address of the terminal device 15 to the terminal device 13 through Internet according to the request and the telephone number “2968-4321”. Finally, the terminal device 13 then makes the connection with the terminal device 15 via Internet according to the received IP address of the terminal device 15.

With reference to FIG. 4, when the terminal device 13 is going to make a connection with the terminal device 16, the caller dials a conventional telephone number “0-3-531-1357” with the terminal device 13. The terminal device 13 then outputs a request to the office-code serving unit 311 through Internet according to the telephone number “0-3-531-1357”. The office-code serving unit 311 analyzes the telephone number including the long-distance access code “0” and thus determines that the telephone number “0-3-531-1357” represents a cross-region long-distance telephone number. Accordingly, the office-code serving unit 311 transmits the request to the area-code serving unit 321 through Internet. Similarly, the area-code serving unit 321 determines that the telephone number “0-3-531-1357” represents a cross-region long-distance telephone number and transmits the request to the country-code serving unit 331 through Internet. In this case, the country-code serving unit 331 records the area code “3” of the area-code serving unit 322. Thus, when receiving the request from the area-code serving unit 321 through Internet, the country-code serving unit 331 transmits the request to the area-code serving unit 322, which records the office code “531” of the office-code serving unit 313, through Internet. Then, the area-code serving unit 322 transmits the request to the office-code serving unit 313, which records the local number and IP address of the terminal device 16. When receiving the request from the area-code serving unit 322 through Internet, the office-code serving unit 313 returns the IP address of the terminal device 16 to the terminal device 13 through Internet according to the request and the telephone number “0-3-531-1357”. Finally, the terminal device 13 then makes the connection with the terminal device 16 via Internet according to the received IP address of the terminal device 16.

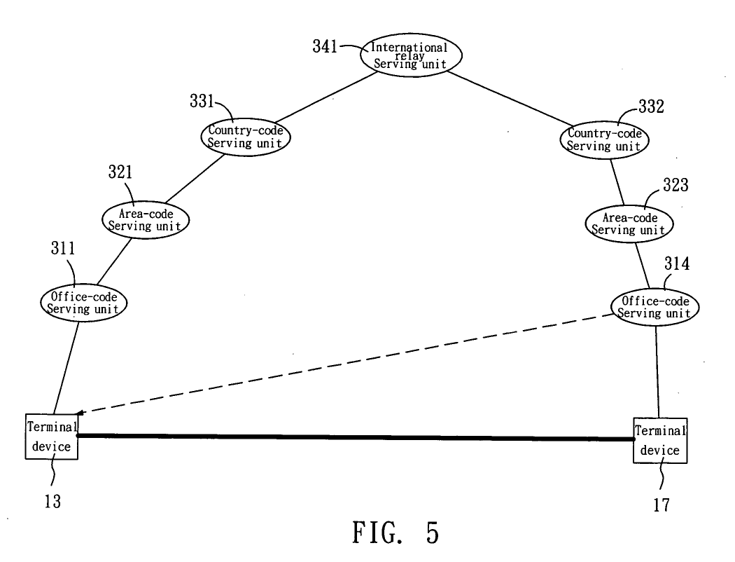

With reference to FIG. 5, when the terminal device 13 is going to make a connection with the terminal device 17, the caller dials a conventional telephone number “002-1408-6261-2468” with the terminal device 13. The terminal device 13 then outputs a request to the office-code serving unit 311 through Internet according to the telephone number “002-1-408-6261-2468”. The office-code serving unit 311 analyzes the telephone number including the international access code “002” and thus determines that the telephone number “002-1408-6261-2468” represents a cross-nation international telephone number. Accordingly, the office-code serving unit 311 transmits the request to the area-code serving unit 321 through Internet. Similarly, the area-code serving unit 321 determines that the telephone number “002-1408-6261-2468” represents a cross-nation international telephone number and transmits the request to the country-code serving unit 331 through Internet. After that, the country-code serving unit 331 determines that the telephone number “002-1408-6261-2468” represents a cross-nation international telephone number and transmits the request to the international relay serving unit 341 through Internet. In this case, the international relay serving unit 341 records the country code “1” of the country-code serving unit 332. Thus, when receiving the request from the country-code serving unit 331 through Internet, the international relay serving unit 341 transmits the request to the country-code serving unit 332, which records the area code “408” of the area-code serving unit 323, through Internet. After that, when receiving the request from the international relay serving unit 341 through Internet, the country-code serving unit 332 transmits the request to the area-code serving unit 323, which records the office code “6261” of the office-code serving unit 314, through Internet. Then, the area-code serving unit 323 transmits the request to the office-code serving unit 314, which records the local number and IP address of the terminal device 17. When receiving the request from the area-code serving unit 323 through Internet, the office-code serving unit 314 returns the IP address of the terminal device 17 to the terminal device 13 through Internet according to the request and the telephone number “002-1408-6261-2468”. Finally, the terminal device 13 then makes the connection with the terminal device 17 via Internet according to the received IP address of the terminal device 17.

As mentioned above, the telephone numbers “8226-0001”, “2968-4321”, “0-3-531-1357”, and “002-1408-6261-2468” are set under the rules (E. 164 Standard) of International Telecommunication Union (ITU). Besides, the telephone numbers are transmitted accompanying with the request.

In summary, the Internet telephone network system of the invention utilizes several serving units including the office-code serving unit, the area-code serving unit, the country-code serving unit, and the international relay serving unit to establish the virtual exchange system. Therefore, the connections between the serving units are established through Internet, so that the request can be transmitted through Internet. The Internet telephone network system of the invention can thus establish the telephone network system without the conventional exchanges and allow the user to make a phone call by dialing the telephone number conforming to the E. 164 Standard of the ITU. As a result, the cost of the conventional exchangers and the accommodating place thereof can be saved, and the system capacity for the available terminal devices can be largely extended.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An Internet telephone network system, which is cooperated with a plurality of terminal devices, wherein each of the terminal devices has a local number and an IP address, the system comprising:
at least two office-code serving units, which respectively have an office code and a connection with at least one of the terminal devices through Internet, wherein the office-code serving units record the local numbers and the IP addresses of the corresponding terminal devices, respectively; and
at least one area-code serving unit, which has an area code and connections with at least one of the office-code serving units through Internet, wherein the area-code serving unit records the office code of the corresponding office-code serving unit, the local numbers, the office codes, and the area code are set under the rules of International Telecommunication Union (ITU), and when a first terminal device of the terminal devices is going to make a connection with a second terminal device of the terminal devices, the system receives a request from the first terminal device through Internet, and returns the IP address of the second terminal device to the first terminal device through Internet according to the request, and the first terminal device then makes a connection with the second terminal device via Internet according to the received IP address.

2. The system of claim 1, wherein when the first terminal device is going to make the connection with the second terminal device, and the first terminal device and the second terminal devices are connected to the same one of the office-code serving units, the office-code serving unit receives the request from the first terminal device through Internet and returns the IP address of the second terminal device to the first terminal device through Internet according to the request, and the first terminal device then makes the connection with the second terminal device via Internet according to the received IP address.

3. The system of claim 1, wherein when the first terminal device is going to make the connection with the second terminal device, the first terminal device is connected to a first office-code serving unit of the office-code serving units, the second terminal device is connected to a second office-code serving unit of the office-code serving units, and the first office-code serving unit and the second office-code serving unit are connected to the area-code serving unit, the first office-code serving unit receives the request from the first terminal device through Internet and transmits the request to the area-code serving unit through Internet, the area-code serving unit transmits the request to the second office-code serving unit through Internet, the second office-code serving unit returns the IP address of the second terminal device to the first terminal device through Internet according to the request, and the first terminal device then makes the connection with the second terminal device via Internet according to the received IP address.

4. The system of claim 1, wherein the system comprises at least two area-code serving units and further comprises:
at least one country-code serving unit, which has a country code and a connection with at least one of the area-code serving units through Internet, wherein the country-code serving unit records the area code of the corresponding area-code serving unit, and the country code is set under the rules of International Telecommunication Union (ITU).

5. The system of claim 4, wherein when the first terminal device is going to make the connection with the second terminal device, and the first terminal device and the second terminal devices are connected to the same one of the office-code serving units, the office-code serving unit receives the request from the first terminal device through Internet and returns the IP address of the second terminal device to the first terminal device through Internet according to the request, and the first terminal device then makes the connection with the second terminal device via Internet according to the received IP address.

6. The system of claim 4, wherein when the first terminal device is going to make the connection with the second terminal device, the first terminal device is connected to a first office-code serving unit of the office-code serving units, the second terminal device is connected to a second office-code serving unit of the office-code serving units, and the first office-code serving unit and the second office-code serving unit are connected to the same one of the area-code serving units, the first office-code serving unit receives the request from the first terminal device through Internet and transmits the request to the area-code serving unit through Internet, the area-code serving unit transmits the request to the second office-code serving unit through Internet, the second office-code serving unit returns the IP address of the second terminal device to the first terminal device through Internet according to the request, and the first terminal device then makes the connection with the second terminal device via Internet according to the received IP address.

7. The system of claim 4, wherein when the first terminal device is going to make the connection with the second terminal device, the first terminal device is connected to a first office-code serving unit of the office-code serving units, the first office-code is connected to a first area-code serving unit of the area-code serving units, the second terminal device is connected to a second office-code serving unit of the office-code serving units, the second office-code serving unit is connected to a second area-code serving unit of the area-code serving units, and the first area-code serving unit and the second area-code serving unit are connected to the same country-code serving unit, the first office-code serving unit receives the request from the first terminal device through Internet and transmits the request to the first area-code serving unit through Internet, the first area-code serving unit transmits the request to the country-code serving unit through Internet, the country-code serving unit transmits the request to the second area-code serving unit through Internet, the second area-code serving unit transmits the request to the second office-code serving unit through Internet, the second office-code serving unit returns the IP address of the second terminal device to the first terminal device through Internet according to the request, and the first terminal device then makes the connection with the second terminal device via Internet according to the received IP address.

8. The system of claim 4, wherein the system comprises at least two country-code serving units and further comprises:
at least one international relay serving unit, which has connections with the country-code serving units through Internet, wherein the international relay serving unit records the country codes of the country-code serving units.

9. The system of claim 8, wherein when the first terminal device is going to make the connection with the second terminal device, and the first terminal device and the second terminal devices are connected to the same one of the office-code serving units, the office-code serving unit receives the request from the first terminal device through Internet and returns the IP address of the second terminal device to the first terminal device through Internet according to the request, and the first terminal device then makes the connection with the second terminal device via Internet according to the received IP address.

10. The system of claim 8, wherein when the first terminal device is going to make the connection with the second terminal device, the first terminal device is connected to a first office-code serving unit of the office-code serving units, the second terminal device is connected to a second office-code serving unit of the office-code serving units, and the first office-code serving unit and the second office-code serving unit are connected to the same one of the area-code serving units, the first office-code serving unit receives the request from the first terminal device through Internet and transmits the request to the area-code serving unit through Internet, the area-code serving unit transmits the request to the second office-code serving unit through Internet, the second office-code serving unit returns the IP address of the second terminal device to the first terminal device through Internet according to the request, and the first terminal device then makes the connection with the second terminal device via Internet according to the received IP address.

11. The system of claim 8, wherein when the first terminal device is going to make the connection with the second terminal device, the first terminal device is connected to a first office-code serving unit of the office-code serving units, the first office-code is connected to a first area-code serving unit of the area-code serving units, the second terminal device is connected to a second office-code serving unit of the office-code serving units, the second office-code serving unit is connected to a second area-code serving unit of the area-code serving units, and the first area-code serving unit and the second area-code serving unit are connected to the same country-code serving unit, the first office-code serving unit receives the request from the first terminal device through Internet and transmits the request to the first area-code serving unit through Internet, the first area-code serving unit transmits the request to the country-code serving unit through Internet, the country-code serving unit transmits the request to the second area-code serving unit through Internet, the second area-code serving unit transmits the request to the second office-code serving unit through Internet, the second office-code serving unit returns the IP address of the second terminal device to the first terminal device through Internet according to the request, and the first terminal device then makes the connection with the second terminal device via Internet according to the received IP address.

12. The system of claim 8, wherein when the first terminal device is going to make the connection with the second terminal device, the first terminal device is connected to a first office-code serving unit of the office-code serving units, the first office-code is connected to a first area-code serving unit of the area-code serving units, the first area-code serving unit is connected to a first country-code serving unit of the country-code serving units, the second terminal device is connected to a second office-code serving unit of the office-code serving units, the second office-code serving unit is connected to a second area-code serving unit of the area-code serving units, the second area-code serving unit is connected to a second country-code serving unit of the country-code serving units, and the first country-code serving unit and the second country-code serving unit are connected to the same international relay serving unit, the first office-code serving unit receives the request from the first terminal device through Internet and transmits the request to the first area-code serving unit through Internet, the first area-code serving unit transmits the request to the first country-code serving unit through Internet, the first country-code serving unit transmits the request to the international relay serving unit through Internet, the international relay serving unit transmits the request to the second country-code serving unit through Internet, the second country-code serving unit transmits the request to the second area-code serving unit through Internet, the second area-code serving unit transmits the request to the second office-code serving unit through Internet, the second office-code serving unit returns the IP address of the second terminal device to the first terminal device through Internet according to the request, and the first terminal device then makes the connection with the second terminal device via Internet according to the received IP address.

13. The system of claim 1, wherein the request outputted from the first terminal device comprises a telephone number of E.164 Standard issued by International Telecommunication Union (ITU).

14. An Internet telephone network system, which is cooperated with a plurality of terminal devices, wherein each of the terminal devices has a local number and an IP address, the system comprising:
at least two office-code serving units, which respectively have an office code and a connection with at least one of the terminal devices through Internet, wherein the office-code serving units record the local numbers and the IP addresses of the corresponding terminal devices, respectively;
at least two area-code serving units, which respectively have an area code and a connection with at least one of the office-code serving units through Internet, wherein the area-code serving units record the office codes of the corresponding office-code serving units, respectively;
at least two country-code serving units, which respectively have a country code and a connection with at least one of the area-code serving units through Internet, wherein the country-code serving units record the area codes of the corresponding area-code serving units, respectively; and
at least one international relay serving unit, which has connections with the country-code serving units through Internet, and records the country codes of the country-code serving units,
wherein the local numbers, the office codes, the area codes, and the country codes are set under the rules of International Telecommunication Union (ITU), and when a first terminal device of the terminal devices is going to make a connection with a second terminal device of the terminal devices, the system receives a request from the first terminal device through Internet, and returns the IP address of the second terminal device to the first terminal device through Internet according to the request, and the first terminal device then makes a connection with the second terminal device via Internet according to the received IP address.

15. The system of claim 14, wherein when the first terminal device is going to make the connection with the second terminal device, and the first terminal device and the second terminal devices are connected to the same one of the office-code serving units, the office-code serving unit receives the request from the first terminal device through Internet and returns the IP address of the second terminal device to the first terminal device through Internet according to the request, and the first terminal device then makes the connection with the second terminal device via Internet according to the received IP address.

16. The system of claim 14, wherein when the first terminal device is going to make the connection with the second terminal device, the first terminal device is connected to a first office-code serving unit of the office-code serving units, the second terminal device is connected to a second office-code serving unit of the office-code serving units, and the first office-code serving unit and the second office-code serving unit are connected to the same one of the area-code serving units, the first office-code serving unit receives the request from the first terminal device through Internet and transmits the request to the area-code serving unit through Internet, the area-code serving unit transmits the request to the second office-code serving unit through Internet, the second office-code serving unit returns the IP address of the second terminal device to the first terminal device through Internet according to the request, and the first terminal device then makes the connection with the second terminal device via Internet according to the received IP address.

17. The system of claim 14, wherein when the first terminal device is going to make the connection with the second terminal device, the first terminal device is connected to a first office-code serving unit of the office-code serving units, the first office-code is connected to a first area-code serving unit of the area-code serving units, the second terminal device is connected to a second office-code serving unit of the office-code serving units, the second office-code serving unit is connected to a second area-code serving unit of the area-code serving units, and the first area-code serving unit and the second area-code serving unit are connected to the same country-code serving unit, the first office-code serving unit receives the request from the first terminal device through Internet and transmits the request to the first area-code serving unit through Internet, the first area-code serving unit transmits the request to the country-code serving unit through Internet, the country-code serving unit transmits the request to the second area-code serving unit through Internet, the second area-code serving unit transmits the request to the second office-code serving unit through Internet, the second office-code serving unit returns the IP address of the second terminal device to the first terminal device through Internet according to the request, and the first terminal device then makes the connection with the second terminal device via Internet according to the received IP address.

18. The system of claim 14, wherein when the first terminal device is going to make the connection with the second terminal device, the first terminal device is connected to a first office-code serving unit of the office-code serving units, the first office-code is connected to a first area-code serving unit of the area-code serving units, the first area-code serving unit is connected to a first country-code serving unit of the country-code serving units, the second terminal device is connected to a second office-code serving unit of the office-code serving units, the second office-code serving unit is connected to a second area-code serving unit of the area-code serving units, the second area-code serving unit is connected to a second country-code serving unit of the country-code serving units, and the first country-code serving unit and the second country-code serving unit are connected to the international relay serving unit, the first office-code serving unit receives the request from the first terminal device through Internet and transmits the request to the first area-code serving unit through Internet, the first area-code serving unit transmits the request to the first country-code serving unit through Internet, the first country-code serving unit transmits the request to the international relay serving unit through Internet, the international relay serving unit transmits the request to the second country-code serving unit through Internet, the second country-code serving unit transmits the request to the second area-code serving unit through Internet, the second area-code serving unit transmits the request to the second office-code serving unit through Internet, the second office-code serving unit returns the IP address of the second terminal device to the first terminal device through Internet according to the request, and the first terminal device then makes the connection with the second terminal device via Internet according to the received IP address.

19. The system of claim 14, wherein the request outputted from the first terminal device comprises a telephone number of E.164 Standard issued by International Telecommunication Union (ITU).
